(19) United States
(12) Patent Application Publication
(10) Pub. No.: US 2007/0078816 A1
(43) Pub. Date: Apr. 5, 2007

(54) Common sub-expression elimination for inverse query evaluation

(75) Inventors: Aaron A. Stern, Bellevue, WA (US); Pompiliu Diplan, Seattle, WA (US); Geary L. Eppley, Carnation, WA (US); Umesh Madan, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/244,724

(22) Filed: Oct. 5, 2005

(51) Int. Cl. G06F 17/30

(52) U.S. Cl. 707/2

(57) ABSTRACT

Provided herein are optimizations for an instruction tree of an inverse query engine. Secondary sub-expression elimination trees are provided, which are data structures configured to include nodes that allow for temporary variables that hold processing context or state for idempotent fragments of query expression(s). As such, when sub-paths for a query expression are processed against a message, the processing context may be stored within nodes of one or more sub-expression elimination trees. The next time this same fragment is processed, regardless of where it appears within the instruction tree, the data structure is accessed to identify and retrieve the state information such that the idempotent fragment is only calculated or evaluated once.

### CROSS-REFERENCE TO RELATED APPLICATIONS

N/A

### BACKGROUND

### Background and Relevant Art

Computing systems—i.e. devices capable of processing electronic data such as computers, telephones, Personal Digital Assistants (PDA), etc.—communicate with other computing systems by exchanging data messages according to a communications protocol that is recognizable by the systems. Such a system utilizes filter engines containing queries that are used to analyze messages that are sent and/or received by the system and to determine if and how the messages will be processed further.

A filter engine may also be called an “inverse query engine.” Unlike a database, wherein an input query is tried against a collection of data records, an inverse query engine tries an input against a collection of queries. Each query includes one or more conditions, criteria, or rules that must be satisfied by an input for the query to evaluate to true against the input.

An XPath filter engine is a type of inverse query engine in which the filters are defined using the XPath language. The message bus filter engine matches filters against eXtensible Markup Language (XML) to evaluate which filters return true, and which return false. In one conventional implementation, the XML input may be a Simple Object Access Protocol (SOAP) envelope or other XML document received over a network.

A collection of queries usually takes the form of one or more filter tables that may contain hundreds or thousands of queries, and each query may contain several conditions. Significant system resources (e.g., setting up query contexts, allocating buffers, maintaining stacks, etc.) are required to process an input against each query in the filter table(s) and, therefore, processing an input against hundreds or thousands of queries can be quite expensive.

Queries included in a particular system may be somewhat similar since the queries are used within the system to handle data in a like manner. As a result, several queries may contain common portions or sub-expressions that typically had to be evaluated individually. Recent, however, developments have allowed identifying redundant portions of query expressions in an attempt to reduce the processing required to evaluate each expression against inputs for each message or XML document. Although these systems allow for the processing of query expressions to occur more rapidly, there are still several drawbacks and shortcomings to such systems.

For example, some inverse query systems represent an expression as a hierarchical instruction tree, in which each node of the instruction tree represents an instruction, and in which each branch of an execution path in the instruction tree when executed from a root node to a terminating branch node represents a full query expression. The instruction tree, however, only allows for the merging of compiled sub-paths if, and only if, the redundant work occurs at the same point in the compiled forms. In other words, in order for the sub-expressions to be considered redundant, they must typically be in the same position within the query expression (e.g., the XPath expression) for the instruction tree to be able to merge them. As such, equivalent sub-expressions that are nested within different portions of the compiled code must still be redundantly evaluated, causing unneeded extra work.

### BRIEF SUMMARY

The above-identified deficiencies and drawback of current inverse query engines are overcome through example embodiments of the present invention. For example, embodiments described herein provide for optimizing inverse query engines configured to access an instruction tree by creating one or more sub-expression elimination trees configured to cache idempotent portions of query expressions that can then be merged and used in identifying redundant portions of query expressions regardless of where they occur in their compiled forms within the instruction tree. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example embodiments provides for the above mentioned optimization by iterating over a compiled query expression within an instruction tree, in which each node of the instruction tree represents an instruction, and in which each branch of an execution path in the instruction tree when executed from the root node to terminating branch node represents a query expression. Idempotent fragment(s) of the query expression are identified and stored as node(s) within sub-expression elimination tree(s). The node(s) represent a temporary variable for processing context of the idempotent fragments such that as they are evaluated against a message their processing context is cached within the node(s) for future use by other query sub-expressions. Within the instruction tree, the idempotent fragment(s) are replaced with marker(s) that maps to the corresponding node(s). Accordingly, during evaluation of a message against the instruction tree, when the marker(s) are identified they will be used in retrieving the processing context, if any, of the idempotent fragment(s) in order to eliminate having to do redundant work on the message.

Another example embodiment provides for efficiently evaluating a message against the instruction tree by using sub-expression elimination tree(s) configured to cache idempotent portion(s) of query expressions. In this embodiment, compiled instructions of a query expression in an instruction tree are sequentially executed based on inputs within a received message. During the execution of the compiled instructions, marker(s) are identified that map to node(s) within the sub-expression elimination tree(s). These node(s) represent temporary variable(s) for processing context of idempotent fragment(s) for the query expression. Thereafter, the node(s) within the sub-expression elimination tree(s) are accessed to determine if processing context of the idempotent fragment(s) is cached therein. If the node(s) include the processing context, the processing context is returned. If, however, the node(s) do not include the processing context, the idempotent fragment(s) are executed and the processing context thereof stored in the node(s) in order to eliminate having to do redundant work on the message for subsequent evaluations.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an inverse query engine cooperatively interacting with an instruction tree to perform inverse querying against an input;

FIG. 2A illustrates an example of an instruction tree for an inverse query filter engine;

FIG. 2B illustrates an intermediary instruction tree that has been optimized using sub-expression elimination techniques in accordance with example embodiments;

FIG. 2C illustrates a sub-expression elimination tree and modified instruction tree in accordance with example embodiments;

FIG. 2D illustrates a merged instruction tree using sub-expression elimination in accordance with exemplary embodiments;

FIG. 3A illustrates a flow diagram for a method of optimizing an instruction tree in accordance with example embodiments; and

FIG. 3B illustrates a flow diagram of a method of efficiently evaluating a message against an instruction tree in accordance with example embodiments.

### DETAILED DESCRIPTION

The present invention extends to methods, systems, and computer program products for efficiently performing sub-expression elimination by merging identifying redundant portions of query expressions regardless of where they occur in their compiled forms within an instruction tree. The embodiments of the present invention may comprise a special purpose or general-purpose computer including various computer hardware, as discussed in greater detail below.

Example embodiments allow for eliminating redundant work for query expressions that have commonality among their sub-paths by using common sub-expressions elimination techniques described herein. When the expressions are in their compiled form, the expressions can be iterated over in order to determine idempotent fragments, which will return the same result given the same input regardless of where they occur in compiled form within an instruction tree. Examples of such idempotent fragments include absolute paths (i.e., paths that start from the root node of a message), and functions or operations that take no arguments and always return the same result no matter where they appear within the instruction tree. Accordingly, these idempotent fragments are removed from the instruction tree and stored in sub-expression elimination tree(s), wherein each node in such tree(s) represents a temporary variable for processing context or state of the idempotent fragments.

The holes left from the removal of the fragments in the instruction tree are then replaced with marker(s), which map to the node(s) within the sub-expression elimination tree(s). When a message is processed against the optimized instruction tree, as the markers are evaluated the sub-expression elimination tree is populated with the processing context thereof. As such, the next time the marker is identified by other instructions in the evaluation of the message, the processing context is accessed from the temporary storage within the sub-expression elimination tree and the evaluation continues without having to redundantly process the sub-expression. Because the sub-expression elimination tree(s) are created using the idempotent portions of the instruction tree, the fragments can be merged regardless of where they occur within the instruction tree.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

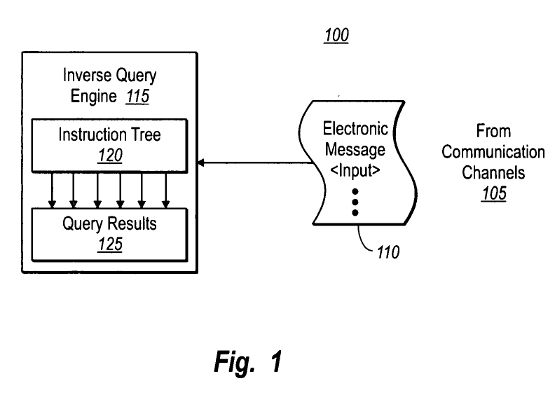

FIG. 1 illustrates an environment 100 in which an inverse query engine 115 cooperatively interacts with an instruction tree 120 to efficiently perform inverse querying against input from a message 110 to generate query results 125. In the illustrated example, an electronic message 110 with various inputs is evaluated using the inverse query engine 115. When executed, the electronic message 110 may be received over the communication channels 105. Alternatively, the electronic message 110 may be accessed from memory, storage, or received from any number of input components. In one embodiment, the electronic message is a hierarchically-structured document such as an eXtensible Markup Language (XML) document or a Simple Object Access Protocol (SOAP) envelope.

Although the instruction tree 120 is illustrated schematically as a box in FIG. 1, the instruction tree is actually a hierarchical tree that represents execution paths for a plurality of queries. Each node of the instruction tree represents an instruction, and each branch in the instruction tree when executed from a root node to terminating branch node represents a full query expression.

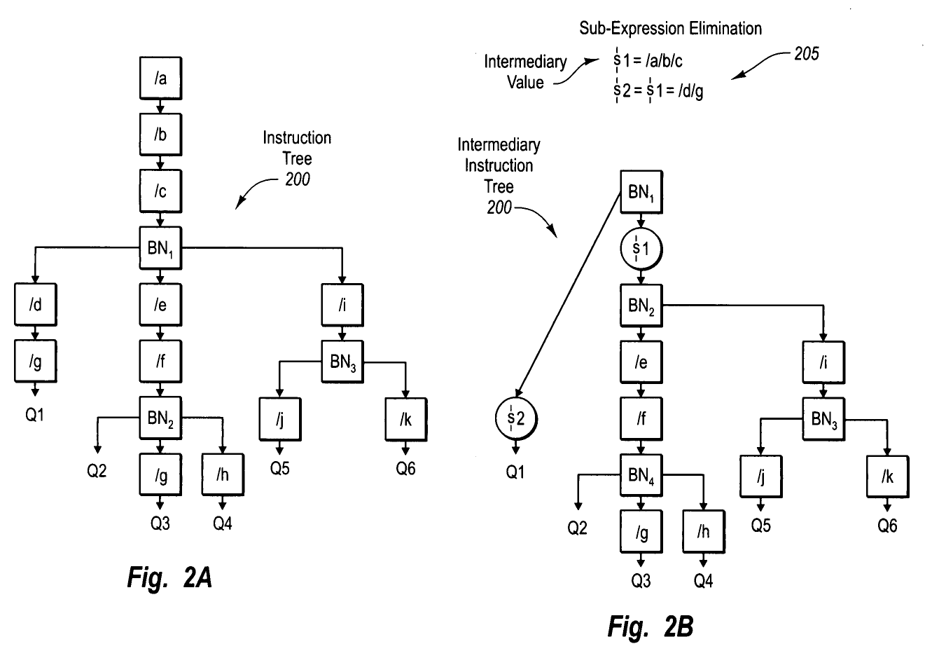

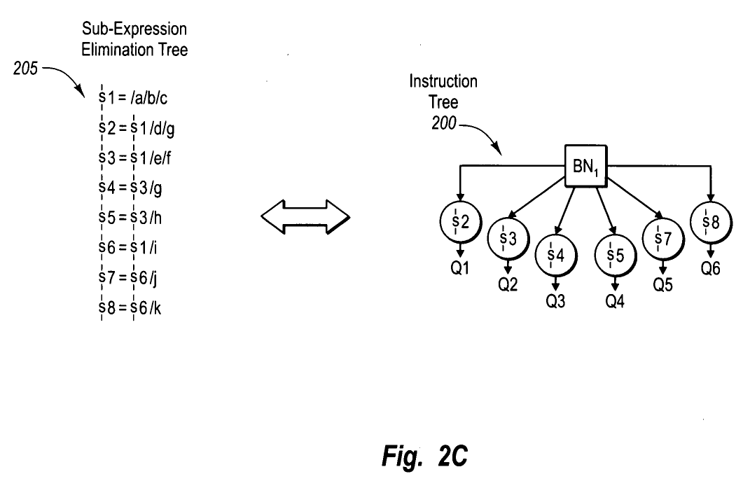

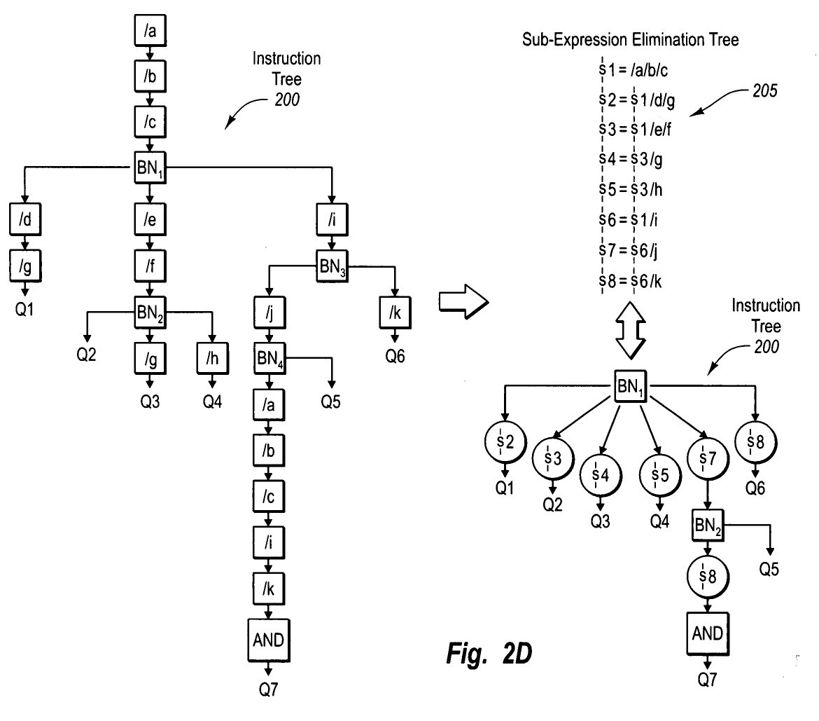

To clarify this principle, a specific example is provided with respect to FIG. 2A. Note, however, the instruction tree is not limited to any particular type of data structure. In fact, embodiments described herein may be used for optimizing any type of hierarchical data structure used in any type of inverse query engine. As such, any specific type of instruction tree as described herein is used for illustrative purposes only and is not meant to limit or otherwise narrow the scope of the present invention unless explicitly claimed.

FIG. 2A illustrates an instruction tree 200 with a plurality of merged query paths, wherein each path in the instruction tree represents the compiled code of six possible query expressions. Specifically, as one navigates from the root node to the terminating node in each ancestral line of the instruction tree 200, one finds the execution path for each of the six queries Q1 to Q6 with the inclusion of the occasional branching node to help preserve context at the appropriate time. More specifically, the sequential processing of each query may be logically divided into groups of one or more computer-executable instructions.

These groups are represented in FIG. 2A using groups “/a” through “/k” with “/a” representing the root node. For example, query Q1 is processed by sequentially executing instruction groups “/a/b/c/d/g”. Query Q2 is processed by sequentially executing instruction groups “/a/b/c/e/f”. Query Q3 is processed by sequentially executing instruction groups “/a/b/c/e/f/g”. Query Q4 is processed by sequentially executing instruction group “/a/b/c/e/f/h”. Query Q5 is processed by sequentially executing instruction group “/a/b/c/i/j”. Finally, Query Q6 is processed by sequentially executing instruction group “/a/b/c/i/k”. Although there may be execution loops within a given instruction group, execution never proceeds backwards from one instruction group to an already processed instruction group.

A “stem” of the instruction tree is defined as those instructions that lead from a root node of the instruction tree to the first branching node of the instruction tree. For example, the instruction tree 200 has a root node “/a” and a first branching node “BN₁”. Accordingly, the stem of the instruction tree is represented by the instruction group sequence “/a/b/c”. The first branching node will also be referred to herein as a “first-order” branching node or “main” branching node. For example, node “BN₁” is the first-order or main branching node of instruction tree 200.

Branching from the main branching node are several first-order or main branches or sub-expression paths. For example, the instruction tree 200 has three first-order sub-expression paths, one beginning with instruction group “/d”, a second beginning with instruction group “/e”, and a third beginning with instruction group “/i”. The first-order branch may potentially contain second-order branching node extending into second order branches, and so on and so forth. For example, the first-order branch beginning with instruction group “/d” has no second-order branching node. On the other hand, the first-order branch beginning with instruction group “/e” does have a second-order branching node “BN₂” that extends into three second-order branches. One of these second-order branches leads directly into a termination node for query Q2. A second second-order branch includes instruction group “/g”. A third second-order branch includes instruction group “/h”.

The first-order branch beginning with instruction group “/i” also has a second-order branching node “BN₃” that extends into two second-order branches or sub-expression paths. One of the second-order branches includes instruction group “/j”, and the other includes instruction group “/k”.

It should be noted that a “branch”, “sub-expression”, “sub-path” are referred to herein interchangeably to refer to any portion of an overall expression. For example, the stem “/a/b/c” is a sub-path for all of the queries Q1 to Q6, and the branch formed by “/d/g” extending from main branch “BN₁” is a portion of the query Q1. Note, however, that the stem “a/b/c” although referred to as a sub-expression may also be considered a branch since it extends from the root node “/a”, thereby forming the only branch of the root node. Further, these sub-expressions can be relative or absolute. Those that are absolute are considered idempotent fragments, which will return the same result given the same input regardless of where they occur in their compiled form within an instruction tree. Examples of such idempotent fragments include absolute paths (i.e., paths that start from the root node of a message), and functions or operations that take no arguments and always return the same result or nodeset given the same input (e.g, absolute sub-paths that begin with function calls).

In one embodiment, the queries are XPath queries. XPath is a functional language for representing queries that are often evaluated against XML documents. During conventional evaluation of inverse query paths (such as XPath statements) against XML documents, there is significant looping in order to fully navigate the XML document. For example, if the XML document has one parent element having at least one child element, at least one of the child elements having at least one second-order child element, and at least one of the second-order child elements having at least one third-order child element, there would be a three layer “for” loop nest conventionally used to navigate the tree.

A loop is an expression that executes a group of one or more sub-expressions repeatedly. Each repetition is termed an “iteration”. The number of times a loop iterates over a group of one or more sub-expressions is known as the loop's “iteration count”.

Conventional loops run sequentially from a branching node. A loop with an iteration count of “n” evaluates its groups of one or more sub-expressions “n” times, one iteration at a time, with the second iteration beginning from the branching node only when the first completes. Each of these iterations, however, has implicit overhead, such as the stack manipulation required to make function calls.

Although the instruction tree 200 merges some of the redundant portions, as mentioned before, the merged portions must occur at the same point in the compiled forms. For example, the instruction tree is able to merge the stem portion (i.e., “/a/b/c”) of Q1-Q6 because each of the sub-paths for the query start and end at the same position within the compiled structure. If, on the other hand, the stem appears in some nested or otherwise embedded portion of the instruction tree 200, such fragment will not be recognized as redundant work. As such, this redundant fragment will need to again be evaluated causing unneeded work and wasting valuable system resources.

In accordance with example embodiments described herein, an instruction tree 200 is optimized by providing one or more secondary sub-expression elimination trees. These data structures include nodes that allow for temporary variables configured to hold processing context or state for idempotent fragments of query expression(s). As such, when an idempotent fragment is processed, the context is stored within one or more of the sub-expression elimination trees. The next time this same fragment is processed, regardless of where it appears within the instruction tree, the data structure is accessed to identify and retrieve the state information such that the idempotent fragment is calculated or evaluated only once. Note that typically the nodes in the sub-expression tree 205 for the idempotent fragments will hold state up to the next divergence in the instruction tree 200; however, that need not always be the case.

FIG. 2B illustrates one example of an initial optimization of instruction tree 200 in accordance with exemplary embodiments. In this example, the query expression for Q1 is iterated over to determine idempotent fractions thereof. More specifically, “/a”, “/a/b”, “/a/b/c”, and “/a/b/c/d/g” are recognized as absolute fragment paths of Q1. Using sub-expression elimination and placing each subsequence up to the next divergence into sub-expression eliminator for Q1 produces the following idempotent fragments of: $1=/a/b/c; $2=$1/d/g. Note that $1 is considered an intermediary value since, as will be shown in FIG. 2C, this value can be combined with other sub-expression idempotent fragments. In any event, each idempotent fragment will be represented as a node within a sub-expression elimination tree, wherein each node represents a temporary variable for processing context of the idempotent fragments. Note that if no other queries shared any of the fragments, the fragments may reduce to a single node, e.g., $1=“a/b/c/d/g”. Nevertheless, because other queries share at least the stem, the idempotent fragments are replaced by one or more markers (in this instance “$2” and “$1”) that map to the nodes within the sub-expression elimination tree, as shown in FIG. 2B. As such, the resultant tree includes a first branching node BN₁ with the markers $2 and $1 hanging off of it; and the $1 marker will have a branching node BN₂ with children “/e” and “/i”.

When a message 110 is received by the inverse query engine 115, the instruction tree 200 processes the message similar to those techniques described above. In accordance with example embodiments, however, when a maker is encountered the sub-expression elimination tree 205 is accessed to retrieve processing context, if any, that exists for the marker(s). If this is the first time the marker(s) have been evaluated, no processing context is available. In this instance, the sub-expression elimination tree 205 determines if the parent of the marker has been evaluated. If not, the process is continued up until state is determined. For example, if marker “$2” is identified for the first time, the sub-elimination tree would recognize that no state is currently available. Accordingly, the sub-elimination tree 205 then determines if the parent node “$1” has been evaluated, and so on and so forth until state is returned.

At such point, those idempotent fragments not previously evaluated will be processed, and the values thereof will be stored in the corresponding temporary variable cache provided by the corresponding nodesets of the sub-expression elimination tree 205. Thus, when a marker is subsequently identified during evaluation of another sub-expression (or possibly the same sub-expression) the value(s) are retrieved from the cache in the sub-expression elimination tree 205 and returned for further processing of the full query expression.

Note that although the above sub-expression elimination technique was mainly directed to absolute paths, embodiments herein can be globally applied to other elements within an instruction tree 200. For example, the above sub-expression elimination technique can apply to predicates and other data structures. Note, however, that merging predicates into the sub-expression elimination tree 205 will typically be more complicated than other idempotent fragments. This is largely due to the fact that predicates themselves can be quit complicated and push many intermediate values during their evaluation. Their intermediate state, then, cannot be represented with a single nodeset as with other compiled idempotent fragments.

Accordingly, in order to optimize predicates in accordance with example embodiments described herein (e.g., the divergence technique), more state must be remembered at the branches. This saving of the necessary state to branch the predicates, however, will take a lot of memory space and processing computation. If the desire is to keep the working set small and the implementation simple, the answer may be to explicitly disallow branching predicates. Accordingly, one example allows for holding the entire compiled sequence of the predicate. As such, two compiled predicates will be equal if the compiled forms are equal. A marker can then replace the compiled form in the instruction tree 200 and the path or sub-expression can be merged as normal. The single compiled predicate can have a branch before or after it, but typically should not have one that occurs in the middle of the predicate it contains. Nevertheless, since predicates take a nodeset and return a new nodeset, the caching scheme can remain the same.

Other complications with predicates may also exist. Accordingly, one implementation does not allow for merging of predicates, but instead optimizes idempotent fragments or sub-paths starting at the root and continuing up to but excluding the first predicate. Since this portion of the sub-path is itself a sub-path, the optimization is not a problem. The remainder of the original sub-path in the instruction tree 200 will be able to take the value returned by the optimization in the sub-expression elimination tree 205 and continue evaluating the original sub-path or query expression.

Note embodiments described herein will typically not work for relative paths since the meaning of the expression thereof changes depending on where in the path it appears. Nevertheless, sub-expression elimination as described herein may apply not only to absolute paths and predicates, but may also apply to idempotent functions or operations as well. Such functions or operations should take no arguments and always return the same result no matter how many times they are processed and no matter where they appear within the instruction tree 200. To handle non-nodset operators, however, the temporary variable system may need to be modified to allow any value type. Nevertheless, it may be advisable for some value operators (e.g., equality) to be treated as predicates to take advantage of specialized optimizations.

Further note that the instruction tree 200 and sub-expression tree 200 can take on any type of data structure. For example, the trees may be in the form of a table, string, or other form that can be subdivided into a tree like structure. Accordingly, the term “tree” as described herein should be broadly construed to include any similar type data structure, and any specific reference to any particular data type is used herein for illustrative purposes only and is not meant to limit or otherwise narrow the scope of embodiments described herein.

The above sub-expression elimination may be recursively applied to more idempotent fragments within the instruction tree 200. For example, as shown in FIG. 2C, the sub-expression “a/b/c/e/” can be replaced with the “$3” marker within the instruction tree 200, i.e., $3=$1/e/f. As such, each node in the sub-expression elimination tree 205 is appropriately referenced as shown in FIG. 2C. This process can then recursively be applied to all or a select portion of idempotent fragments identified within the instruction tree 200. As shown in FIG. 2C, all the query expressions have been reduced using sub-expression elimination, and their corresponding idempotent fragments replaced with corresponding markers.

Note that there may be several sub-expression trees 205 created. For example, there may be a sub-expression elimination tree 205 for holding absolute paths as previously described. Other sub-expression trees 205 may be created for location paths that start with idempotent functions or operators whose return value is always the same for any give message. Determining which function these are can be hard coded or determined during compilation, but any function that satisfies the invariant properties can be used as the root of an optimization tree 205 (i.e., a sub-expression elimination tree 205). These sub-expression trees 205 may then be partially or fully merged with one another, depending on their relationships. In addition, portions or entire sub-expression trees 205 can be combined using Boolean operators, thus allowing for more robust mergence than conventional techniques described above. In fact, the sub-expression elimination trees 205 can be evaluated and merged in any manner needed and the values when processed stored in a separate nodeset of a different sub-expression elimination tree 205.

As previously stated, the sub-elimination techniques herein described allow for the merging of expressions regardless of where they occur in compiled form within an instruction tree. FIG. 2D illustrates an example of where such merging may occur. As shown on the left-hand side of FIG. 2D, Instruction tree 200 has been modified by performing an AND operation on Q5 and Q6 (i.e., Q5 ANDed with /a/b/c/d/e/i/k at branch BN₄) to form query expression Q7. Using sub-expression elimination as previously described may produce the resulting instruction tree 200 shown on the right-hand side of FIG. 2D. Note in particular, that the idempotent fragments corresponding to markers $7 and $8 will now only be iterated over once when evaluating Q5, Q6, or Q7, even though these fragments appear in different merged portions of the original instruction tree 200.

Note also that in describing the construction of the sub-expression tree(s) 205 above, the compiled expression paths within the instruction tree 200 appeared to be iterated over starting from the root node forward. Embodiments described herein, however, are not limited to such processing, and may indeed be optimized by other techniques. For example, the expression paths within the instruction trees 200 may be iterated in reverse order starting from end of an expression path and identifying the idempotent fragments up to the root node (e.g., you pull out the absolute paths that started closest to the end of the XPath). Iterating over the query expressions in this manner reduces processing and memory resources used in creating the sub-expression elimination trees 205.

The above described sub-expression elimination can virtually eliminate all redundant work needed to evaluate a set of path expressions (e.g., XPaths). How much work can be save may depend on the relative importance of the working set, setup time, complexity, and evaluation speed. Accordingly, the embodiments described herein may be modified in order to achieve a particular desired result. As such, any specific manner for merging idempotent fragments or otherwise creating sub-expression elimination trees 205 are used herein for illustrative purposes only and are not meant to limit or otherwise narrow the scope of embodiments described herein unless otherwise explicitly claimed.

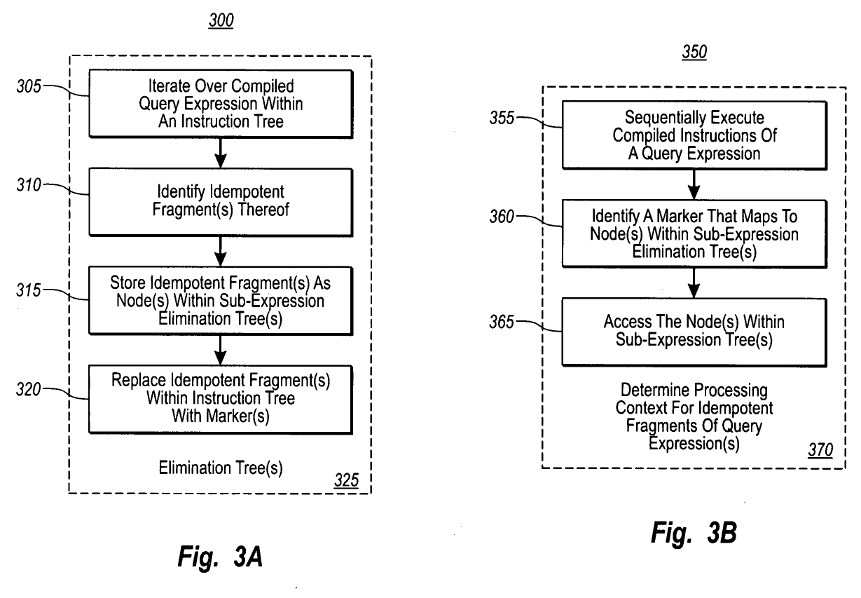

The present invention may also be described in terms of methods comprising functional steps and/or non-functional acts. The following is a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts is the recitation of the claims—and in the following description of the flow diagram for FIGS. 3A and 3B—is used to indicate the desired specific use of such terms. Note, however, that such terms may take on the other form, depending on their relative use.

As previously mentioned, FIGS. 3A and 3B illustrate flow diagrams for various exemplary embodiments described herein. The following description of FIGS. 3A and 3B will occasionally refer to corresponding elements from FIGS. 1 and 2A-C. Although reference may be made to a specific element from these Figures, such elements are used for illustrative purposes only and are not meant to limit or otherwise narrow the scope of the described embodiments unless explicitly claimed.

FIG. 3A illustrates a flow diagram for a method 300 optimizing an instruction tree for an inverse query engine by creating sub-expression elimination tree(s) configured to cache idempotent portions of query expressions that can then be merged and used in identifying redundant portions of query expressions regardless of where they occur in their compiled forms within the instruction tree. Method 300 includes a step for creating 325 sub-expression elimination tree(s). Step for 325 includes an act of iterating 305 over a compiled query expression within an instruction tree. For example, the various query expressions Q1-Q6 within instruction tree 200 may be iterated over, in which each node of the instruction tree 200 represents an instruction, and in which each branch of an execution path in the instruction tree 200 when executed from the root node to terminating branch node represents a query expression Q1-Q6. The query expression(s) may be XPath expression(s) and the inverse query filter engine may be an XPath filter engine. Note that the iteration over the query expression(s) Q1-Q6 within the instruction tree 200 may occur from a terminating point of the query expression(s) back to a root node (e.g., from “/g” to “/a” for Q1) for the instruction tree 200.

Step for 325 also includes an act of identifying 310 idempotent fragments of the query expression. For example, inverse query engine 115 can be used to identify idempotent portions of the query expressions Q1-Q6 for instruction tree 200. These idempotent fragments may be absolute paths and/or functions or operations that takes no arguments and always has the same result for the message. Alternatively, or in addition, these idempotent fragments may be predicates.

Step for 325 further includes an act of storing 315 the idempotent fragment(s) as node(s) within sub-expression elimination tree(s). For example, in FIG. 2B, idempotent fragments “/a/b/c” and “/a/b/c/d” were removed and stored in sub-expression elimination tree 205 as one or more nodes. In general, each node represents a temporary variable for processing context of the idempotent fragments such that as the idempotent fragments are evaluated against a message 110 (e.g., an XML document), their processing context is cached within the nodes for future use by other query sub-expressions. Further note that the idempotent fragment(s) may be merged into a single node, such that the end of the idempotent fragments is a divergence in the instruction tree 200.

Thereafter, step for 325 includes an act of replacing 320 the idempotent fragment(s) within the instruction tree with marker(s) that map to the node(s). For example, in FIG. 2B, the idempotent fragments “/a/b/c” and “/ab/c/d” are replaced with markers “$3” and “$4”, respectively. During evaluation of message 110 against instruction tree 200, the marker(s) when identified will be used in retrieving the processing context, if any, of the idempotent fragments in order to eliminate having to do redundant work on the message.

Multiple sub-expression elimination trees may be created and merged either partially or completely using such things and Boolean operators. Further note that the sub-expression elimination trees may be generated during setup time or dynamically.

FIG. 3B illustrates a flow diagram for a method 350 of efficiently evaluating a message against the instruction tree by using sub-expression elimination tree(s) in accordance with example embodiments. Method 350 includes a step for determining 370 processing context for idempotent fragments of query expression(s). Further, step for 370 includes an act of sequentially executing 355 compiled instructions of a query expression. For example, based on input(s) within a received message 110 (e.g., XML document), the compiled instructions within instruction tree 200 may be sequentially executed starting at root node “/a”.

During the execution of the compiled instructions, step for 370 includes an act of identifying 360 a marker that maps to node(s) within a sub-expression elimination tree(s). For example, as shown in FIG. 2C, during the execution of the compiled instructions in instruction tree 200, the marker(s) “$3”, “$4”, and/or “$6” may be identified that map to their corresponding nodes in sub-expression elimination tree(s) 205. As before, the node(s) within the sub-expression elimination tree(s) represent temporary variable(s) for processing context of idempotent fragment(s) for the query expression.

Step for 370 further includes an act of accessing 365 the node(s) within the sub-expression elimination tree(s). For example, during the evaluation of the message 110 against instruction tree 200, when a marker is identified the corresponding node(s) may be accessed to determine if processing context of the idempotent fragments is cached therein. If the node(s) include the processing context, the processing context may be returned. On the other hand, if the node(s) do not include the processing context, the idempotent fragments are executed and the processing context thereof stored in the node(s) in order to eliminate having to do redundant work on the message for subsequent evaluations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In an inverse query filter engine capable of accessing an instruction tree that represents execution paths for a plurality of queries, a method of optimizing the instruction tree by creating one or more sub-expression elimination trees configured to cache idempotent portions of query expressions that can then be merged and used in identifying redundant portions of query expressions regardless of where they occur in their compiled forms within the instruction tree; the method comprising:
iterating over a compiled query expression within an instruction tree, in which each node of the instruction tree represents an instruction, and in which each branch of an execution path in the instruction tree when executed from the root node to terminating branch node represents a query expression;
identifying one or more idempotent fragments of the query expression;
storing the one or more idempotent fragments as one or more nodes within one or more sub-expression elimination trees, wherein the one or more nodes represent a temporary variable for processing context of the one or more idempotent fragments such that as the one or more idempotent fragments are evaluated against a message their processing context is cached within the one or more nodes for future use by other query sub-expressions;
replacing the one or more idempotent fragments within the instruction tree with one or more markers that map to the one or more nodes, wherein the one or more markers when identified during evaluation of the message against the instruction tree will be used in retrieving the processing context, if any, of the one or more idempotent fragments in order to eliminate having to do redundant work on the message.

2. The method of claim 1, wherein the one or more idempotent fragments are merged into a single tree, such that the end of the one or more idempotent fragments is a divergence in the instruction tree.

3. The method of claim 1, wherein the one or more idempotent fragments are a function or operation that takes no arguments and always has the same result for the message.

4. The method of claim 1, wherein the one or more idempotent fragments are one or more absolute paths.

5. The method of claim 1, wherein the one or more nodes within the one or more markers are merged using one or more Boolean operators.

6. The method of claim 1, wherein the iteration over the query expression within the instruction tree occurs from a terminating point of the query expression back to a root node for the instruction tree.

7. The method of claim 1, wherein the query expression is an XPath expression and the inverse query filter engine is an XPath filter engine.

8. The method of claim 1, wherein the one or more sub-expression elimination trees are generated during setup time.

9. The method of claim 1, wherein the sub-expression elimination trees are generated dynamically.

10. The method of claim 1, wherein the message is an XML document.

11. In an inverse query filter engine capable of accessing an instruction tree that represents execution paths for a plurality of queries, a method of efficiently evaluating a message against the instruction tree by using one or more sub-expression elimination trees configured to cache idempotent portions of query expressions that are used in identifying redundant portions of query expressions regardless of where they occur in their compiled forms within the instruction tree; the method comprising acts of:
sequentially executing compiled instructions of a query expression in an instruction tree based on one or more inputs within a received message;
during the execution of the compiled instructions, identifying a marker that maps to one or more nodes within one or more sub-expression elimination trees, wherein the one or more nodes represent a temporary variable for processing context of one or more idempotent fragments for the query expression;
accessing the one or more nodes within the one or more sub-expression elimination trees to determine if processing context of the one or more idempotent fragments is cached therein, wherein if the one or more nodes include the processing context, the processing context is returned, and wherein if the one or more nodes do not include the processing context, the one or more idempotent fragments are executed and the processing context thereof stored in the one or more nodes in order to eliminate having to do redundant work on the message for subsequent evaluations.

12. The method of claim 11, wherein the one or more idempotent fragments are at least a portion of a predicate.

13. The method of claim 11, wherein the message is an XML document.

14. The method of claim 11, wherein the query expression is an XPath expression and the inverse query filter engine is an XPath filter engine.

15. The method of claim 11, wherein the one or more sub-expression elimination trees are generated during setup time.

16. In an inverse query filter engine capable of accessing an instruction tree that represents execution paths for a plurality of queries, a computer program product configured to implement a method of optimizing the instruction tree by creating one or more sub-expression elimination trees configured to cache idempotent portions of query expressions that can then be merged and used in identifying redundant portions of query expressions regardless of where they occur in their compiled forms within the instruction tree; the computer program product comprising one or more computer readable media having stored thereon computer executable instructions that, when executed by a processor, can cause the inverse query filter engine to perform the following:
iterate over a compiled query expression within an instruction tree, in which each node of the instruction tree represents an instruction, and in which each branch of an execution path in the instruction tree when executed from the root node to terminating branch node represents a query expression;
identify one or more idempotent fragments of the query expression;
storing the one or more idempotent fragments as one or more nodes within one or more sub-expression elimination trees, wherein the one or more nodes represent a temporary variable for processing context of the one or more idempotent fragments such that as the one or more idempotent fragments are evaluated against a message their processing context is cached within the one or more nodes for future use by other query sub-expressions;
replace the one or more idempotent fragments within the instruction tree with one or more markers that map to the one or more nodes, wherein the one or more markers when identified during evaluation of the message against the instruction tree will be used in retrieving the processing context, if any, of the one or more
idempotent fragments in order to eliminate having to do redundant work on the message.

17. The computer program product of claim 16, wherein the one or more idempotent fragments are merged into a single tree, such that the end of the one or more idempotent fragments is a divergence in the instruction tree.

18. The computer program product of claim 16, wherein the one or more idempotent fragments are at least a portion of a predicate.

19. The computer program product of claim 16, wherein the one or more markers are merged using one or more Boolean operators.

20. The computer program product of claim 16, wherein the one or more sub-expression elimination trees are generated during setup time.
